(19) United States
(12) Patent Application Publication
(10) Pub. No.: US 2005/0253027 A1
(43) Pub. Date: Nov. 17, 2005

(54) Conduit anchor

(76) Inventors: Paul Gaudron, Stamford, CT (US); Jeffrey Powers, Larchmont, NY (US)

Correspondence Address: CANTOR COLBURN, LLP, 55 GRIFFIN ROAD SOUTH, BLOOMFIELD, CT, 06002, US

(21) Appl. No.: 10/847,490

(22) Filed: May 17, 2004

(51) Int. Cl. F16L 3/08

(52) U.S. Cl. 248/74.3

(57) ABSTRACT

Disclosed herein is a conduit anchor which includes a base, a strap structure at the base, and an engagement head at the strap structure, the engagement head being receptive to and retentive of a nail gun barrel. Further disclosed herein is a conduit anchor and power fastener driven combination. The combination includes a nail gun having a barrel and an anchor engaged with the barrel. Yet further disclosed herein is a method for fastening an anchor to a surface. The method includes engaging an anchor on a barrel of a nail gun, placing the anchor on a selected surface, and firing the nail gun.

### BACKGROUND

Conduits of many kinds, including soft conduits such as cables and even rigid conduits, such as pipe often must be suspended in building structures. There are clearly a plethora of anchoring devices available in the commercial marketplace that are adapted to be utilized to secure conduits. Securement may be in a suspended condition or may be a “ground” surface to prevent unwanted moving of the conduits placed there.

Prior art anchoring devices are affixed by one or more of adhesive, welded studs, snaps, screws and hammer driven nails. Each of these has drawbacks which limits functionality in the case of adhesives these drawbacks include limited adhesive properties, degradation of the adhesive over time or surface conditions precluding the use of adhesive. While fasteners overcome some of these issues they suffer from other difficulties such as commonly damage to the anchor caused by manually hammering nails through the anchor. Moreover, fastener type anchoring devices are not available for use in some settings such as where concrete is the material to which the anchor is to be attached.

### SUMMARY

Disclosed herein is a conduit anchor which includes a base, a strap structure at the base, and an engagement head at the strap structure, the engagement head being receptive to and retentive of a nail gun barrel.

Further disclosed herein is a conduit anchor and power fastener driven combination. The combination includes a nail gun having a barrel and an anchor engaged with the barrel.

Yet further disclosed herein is a method for fastening an anchor to a surface. The method includes engaging an anchor on a barrel of a nail gun, placing the anchor on a selected surface, and firing the nail gun.

### BRIEF DESCRIPTION OF THE DRAWINGS

Referring now to the drawings wherein like elements are numbered alike in the several Figures:

FIG. 1 is a perspective view of one conduit anchor;

FIG. 2 is a top plan view of the anchor illustrated in FIG. 1;

FIG. 3 is a cross-sectional view of the anchor of FIG. 2 taken along section line 3-3;

FIG. 4 is an elevation view of the anchor of FIG. 1 with a fastener therein;

FIG. 5 is an exploded view of a gun barrel and the anchor before attachment;

FIG. 6 is a view of the anchor attached to the gun barrel ready for deployment;

FIG. 7 is a view of the anchor with a strap thereon;

FIG. 8 is an alternate embodiment utilizing a collet configuration in perspective view.

### DETAILED DESCRIPTION

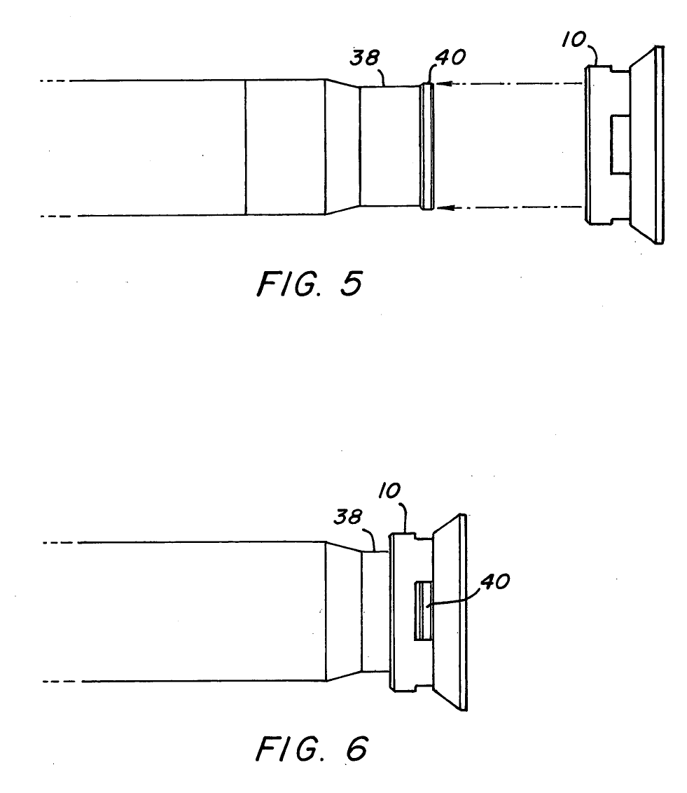

Referring to FIG. 1, an anchor 10 is illustrated in a perspective view. The anchor disclosed herein has many advantages over the prior art in that it is attachable to a support structure (wall, ceiling, ground, floor, etc.) with/by a power driven fastener (See FIGS. 5 and 6). Moreover, the anchor is specifically configured to engage a barrel of a power driven fastener “nail gun” to position the anchor safely and effectively for deployment.

Referring again to FIGS. 1-4 simultaneously, the anchor 10 includes a base 12, having a through bore 14. The bore 14 includes a chamfered edge 16 about a perimetrical edge of bore 14. Base 12 is formed in one embodiment in a cylindrical/frustoconical configuration with the cylindrical portion identified as 18 and the frustoconical portion identified as 20. It is to be appreciated that the specific geometric properties of base 12 illustrated and described represent but one specific embodiment of the anchor and other shapes could be employed as desired. In the illustrated embodiment, portion 18 is intended to be adjacent a support structure when installed while front surface 22 is spaced therefrom.

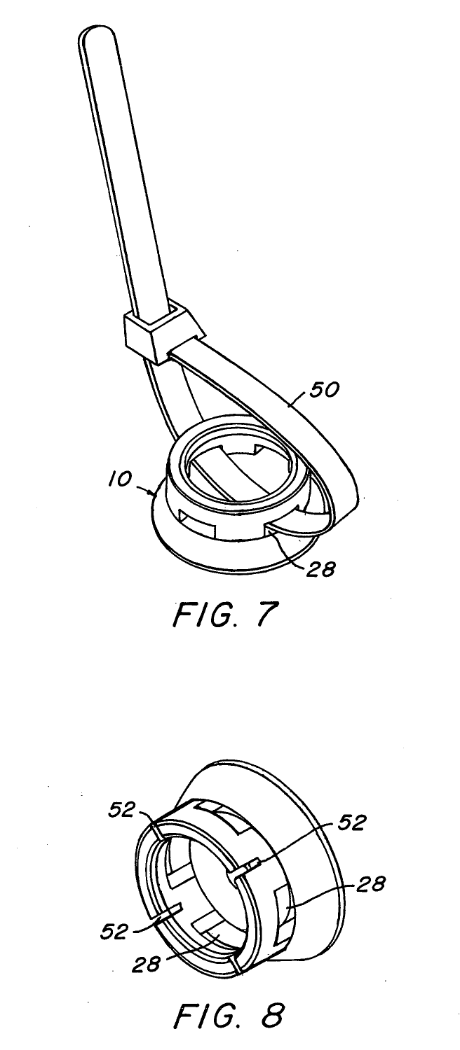

Front surface 22 has, extending therefrom, a strap structure 24 which is receptive to straps 50 (See FIG. 7). Structure 24 includes an opening section 26, which in the illustrated embodiment includes four openings 28. More or fewer are possible and contemplated. Adjacent section 26 and spaced from surface 22 is engagement head 30. Engagement head 30 has two primary purposes: first, head 30 closes openings 28 so that straps (cable ties, etc.) may be inserted and retained in openings 28; and second, head 30 features a profile 32 receptive to a nail gun barrel (See FIG. 5) or an attachment to a nail gun barrel having exterior features substantially similar to those depicted in FIG. 5 (broadly termed bump 40), but in any event, features sufficient to engage and retain anchor 10 in the barrel.

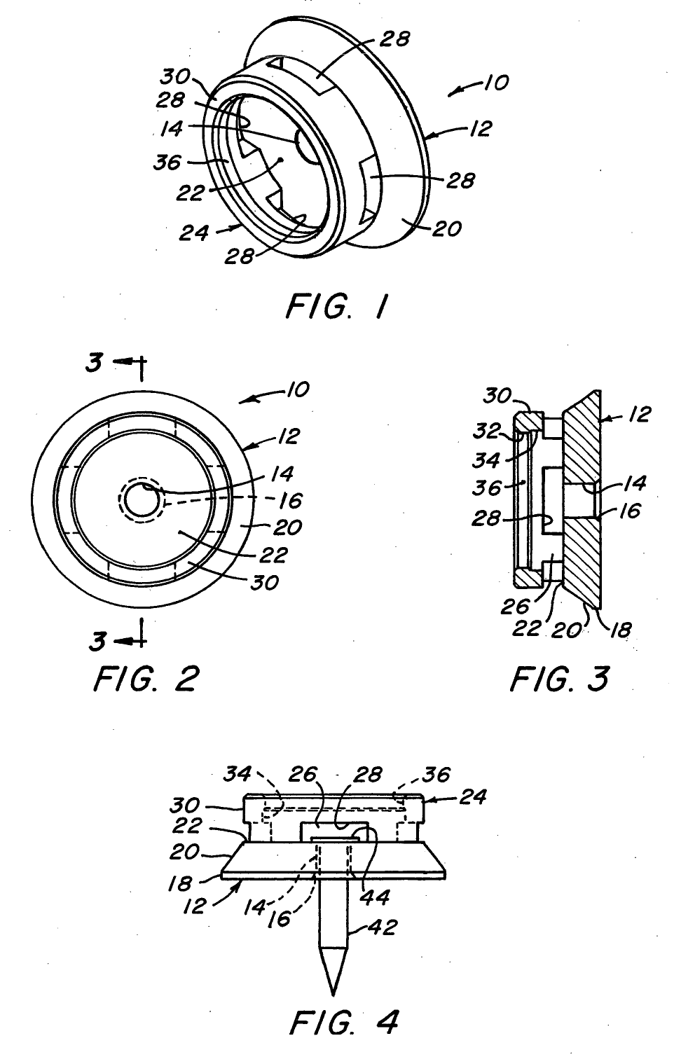

The features of profile 32 making the foregoing possible include, in one embodiment, an undercut 34. It will be appreciated from FIGS. 3 and 4 that profile 32 comprises two main features: These are undercut 34 and bore 36. The diameter (in the case of a cylindrically shaped engagement head 30) of bore 36 (inside diameter) is smaller than the inside diameter of undercut 34. The gun barrel 38 (See FIGS. 5 and 6) includes bump member 40, which may be continuous and generally annular or may be discontinuous (it is noted that the cross-sectional geometry should be sufficient for engagement with anchor 10 even if not of the same geometric shape). During a procedure for mounting the engagement head 30 and therefore anchor 10 to gun barrel 38, the barrel (and bump) are urged into the bore 36. Initially bore 36 will stretch to accommodate the larger perimetrical dimension of bump 40 and then return to pre-stretched measurement when bump 40 reaches undercut 34. In this condition the anchor 10 is engaged with barrel 38 and is ready for deployment. It should also be noted that engagement head 30 may be configured as a collet to reduce force necessary to engage with a barrel of the nail gun. This is illustrated in FIG. 8. The number of gaps 52, that are present in the collet may be varied between a single gap 52 and a large number of gaps up to a practical limit due to amount of material versus width of each gap taking into consideration that the openings 28 must remain structurally capable of retaining strap(s) 50.

Not yet described but likely understood by one of skill in the art based upon the foregoing, the power driven fastener 42 (See FIG. 4) is to be driven through bore 14 with head 44 of fastener 42 landing in contact with surface 22 when the anchor 10 is installed. Once installed anchor 10 is easily removed from engagement with bump 40 by off axial movement of the barrel 38 or a simple axial pull back of barrel 38. It is noted that a combination of these disengagement techniques are also applicable.

The anchor hereof may be connected to any surface penetrable by the power driven fastener 42 including concrete surfaces.

Once the anchor 10 is installed on the support structure, one or more straps 50 (See FIG. 7) may be installed through openings 28. The strap(s) 50 may be installed through two openings 28 as shown or may be installed through a single opening allowing the use of two straps side-by-side in a single anchor. Straps such as cable ties are then extended around a conduit to be secured and the strap is connected to itself by any of a number of means.

It should further be appreciated that the anchor disclosed herein could be utilized with hooks, etc. instead of straps with similar securement goals in some situations.

While preferred embodiments have been shown and described, modifications and substitutions may be made thereto without departing from the spirit and scope of the invention. Accordingly, it is to be understood that the present invention has been described by way of illustrations and not limitation.

1. A conduit anchor comprising:
a base;
a strap structure at the base;
an engagement head at the strap structure, the engagement head being receptive to and retentive of a nail gun barrel.

2. A conduit as claimed in claim 1 wherein the engagement head includes a profile to retain an end of the barrel therein.

3. A conduit as claimed in claim 2 wherein the profile is shaped to receive a bump on the barrel.

4. A conduit as claimed in claim 3 wherein the bump is of a geometric shape complementary to the profile.

5. A conduit as claimed in claim 1 wherein the profile includes an undercut.

6. A conduit as claimed in claim 1 wherein the engagement head includes one or more gaps to perform as a collet.

7. A conduit as claimed in claim 1 wherein the profile is substantially circular in shape.

8. A conduit as claimed in claim 1 wherein the strap structure includes one or more openings to receive one or more straps to secure one or more conduits.

9. A conduit as claimed in claim 1 wherein the base includes a bore receptive of a power driven fastener.

10. A conduit anchor and power fastener driven combination comprising:
a nail gun having a barrel; and
an anchor engaged with the barrel.

11. A conduit anchor and power fastener driven combination as claimed in claim 10 wherein the anchor includes a profile engageable with the barrel for retention on the barrel.

12. A conduit anchor and power fastener driven combination as claimed in claim 10 wherein the barrel includes one or more bumps to retain the anchor.

13. A method for fastening an anchor to a surface comprising:
engaging an anchor on a barrel of a nail gun;
placing the anchor on a selected surface; and
firing the nail gun.

14. A method for fastening an anchor to a surface as claimed in claim 13 wherein the method further includes withdrawing the barrel from the anchor to defeat engagement with the anchor.

15. A method for fastening an anchor to a surface as claimed in claim 13 wherein the engaging includes urging the anchor onto the barrel.

16. A method for fastening an anchor to a surface as claimed in claim 15 wherein the urging is concluded when a profile of the anchor engages a bump on the barrel.

17. A method for fastening an anchor to a surface as claimed in claim 14 wherein the withdrawing is by at least one of axially pulling and off-axis moving of the barrel.

18. A method for anchoring conduits comprising:
carrying out the method of claim 13;
threading a strap through the anchor; and
securing the strap to a conduit.

19. A method for anchoring conduits comprising:
carrying out the method of claim 13;
threading a hook through the anchor; and
securing the hook to a conduit.
